(19) United States
(12) Patent Application Publication
(10) Pub. No.: US 2007/0090234 A1
(43) Pub. Date: Apr. 26, 2007

(54) Multi-function fastening stand

(75) Inventor: Bryant Liao, Taipei (TW)

Correspondence Address: Supa Technology Co., Ltd., Junghe, P.O. Box No. 6-57, Taipei, 235, TW

(73) Assignee: Supa Technology Co., Ltd., Taipei (TW)

(21) Appl. No.: 11/081,627

(22) Filed: May 31, 2005

(51) Int. Cl. F16M 11/38; A45D 19/04

(52) U.S. Cl. 248/127

(57) ABSTRACT

A multi-function fastening stand includes primarily a roughly cone-shaped seat with two sheets installed at an upper section of the seat, for clipping a shaft. A bolt is used to lock the sheets. A lower section of the seat is in a shape of trumpet, and a gear is installed at the top of the lower section. A fastening stand is constituted after pivoting the bottom of the seat to a sucking disc, so as to be attached to a car window or any attachable desktop with the sucking disc, and electronic products such as cellular phones or PDA can be emplaced onto the shaft. A bending angle of the shaft and a rotating angle of the sheets can be adjusted by the loosening and tightening of the bolt.

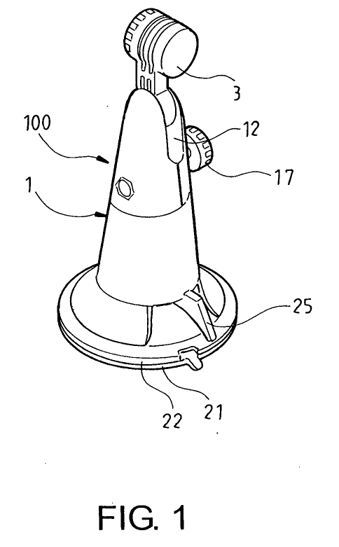

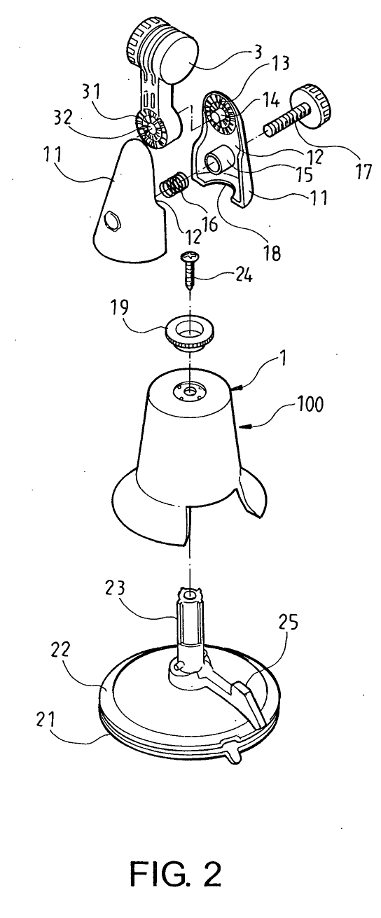

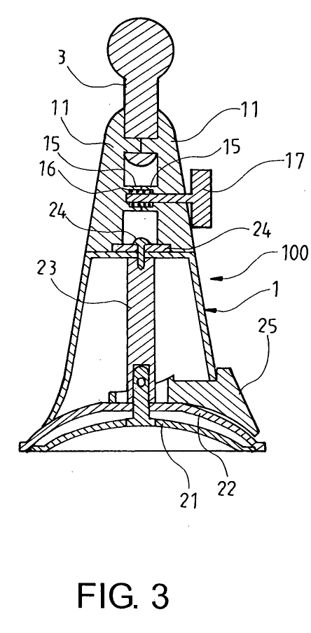

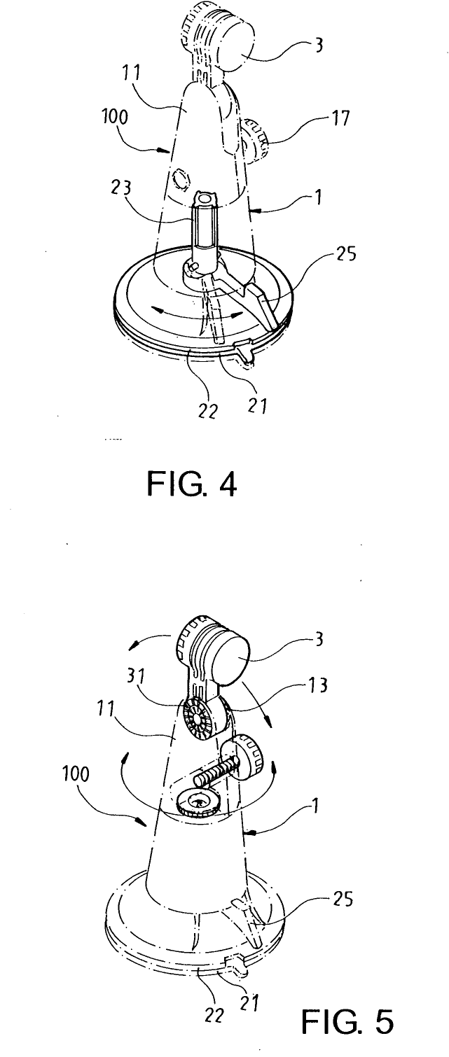

### BACKGROUND OF THE INVENTION

(a) Field of the Invention

The present invention relates to a multi-function fastening stand, and more particularly to a fastening stand for attaching different objects, in order to fasten all kinds of electronic products.

(b) Description of the Prior Art

As the development of technology, electronic products have manifested a versatility, wherein cellular phones, PDA, and GPS have become indispensable personal belongings. Accordingly, how to fasten these products inside a car or in any place has drawn attention to related industries. Of a conventional method of fastening, there is a way of fastening by a sucking disc, in addition to using a hanger. However, for an existing fastening stand using a sucking disc, due to the inconvenience in applying, and an inferior operation method used in adjusting applying angles, an improvement to the fastening stand is needed.

### SUMMARY OF THE INVENTION

The primary object of the present invention is to provide a multi-function fastening stand, so as to conveniently attach and fasten various electronic products to a car or different objects, thereby achieving the purpose of freely adjusting angles.

Accordingly, the aforementioned fastening stand comprises two roughly cone-shaped symmetric sheets mounted at an upper section of a seat, for clipping a shaft. A bolt is used to lock the two sheets, and a lower section of the seat is in a shape of trumpet, with a gear at the top of the seat. A fastening stand is constituted after pivoting a bottom part of the seat to a sucking disc. The sucking disc can be attached in a car or onto any desktop for affixing, electronic products such as cellular phones, or PDA are emplaced on the shaft, and a bending angle of the shaft and a rotating angle of the sheets can be adjusted via the tightening or loosing of the bolt.

Accordingly, in the aforementioned fastening stand, circular tooth parts are installed at an inner edge of the two sheets at the upper section of the seat, with corresponding tooth parts at two sides of the bottom of the shaft, so as to tightly combine the sheets and shaft via the engagement of the tooth parts.

Accordingly, in the aforementioned fastening stand, semicircular notches are installed at an inner edge of the bottom of the two sheets at

What is claimed is:

1. A multi-function fastening stand comprising a seat with two sheets installed at an upper section thereof; an opening located at top of the sheets; circular tooth parts installed at an inner edge at the location of the opening; a fastening pin installed at a center of the tooth part and a cylinder below the sheets; a bolt to lock the sheets after inserting a spring into the cylinder; semicircular notches installed at bottom of the sheets; a lower section of the seat in a shape of trumpet and a gear at the top of the lower section; a shaft with a circular tooth part at the bottom thereof, and a center hole in a center of the tooth part for fixing the fastening pin of the sheets at the upper section of the seat; a sucking disc connected to a fastening seat with a rod pivoting the fastening seat to the seat; a multi-function fastening stand constituted by assembling the aforementioned compartments, allowing the sucking disc attached to a car window or any attachable object, and different electronic products emplaced onto the shaft; the shaft swinging back and forth to any angle and the sheets rotating left and right with the loosening and tightening of the bolt of the seat, thereby adjusting any angle and facilitating an operation of the electronic products.

2. The multi-function fastening stand according to claim 1, wherein the seat can be in a circular or polygonal shape.
